(19) United States
(12) Patent Application Publication
(10) Pub. No.: US 2004/0158514 A1
(43) Pub. Date: Aug. 12, 2004

(54) Method for collecting customer information

(76) Inventor: Shigeru Yoshida, Tokyo (JP)

Correspondence Address: REED SMITH LLP, 3110 FAIRVIEW PARK DRIVE, SUITE 1400, FALLS CHURCH, VA, 22042, US

(21) Appl. No.: 10/360,865

(22) Filed: Feb. 10, 2003

(51) Int. Cl. G06F 17/60

(52) U.S. Cl. 705/35

(57) ABSTRACT

Display means for encouraging customers to enter their predictions for future Nikkei Stock Averages, commodity futures, or number of visitors to or revenue of a retail establishment during a certain future period, along with personal data, such as e-mail addresses and birth dates.

### BACKGROUND OF THE INVENTION

1. Technical Field

The invention relates to a method for collecting customer information. This method encourages customers to submit predictions, for example, for Japan's Nikkei Stock Average (Nikkei Dow Average), the U.S. Dow Jones Industrial Average, commodity futures, number of customer visits to a certain restaurant or retail establishment, or a retail establishment's daily revenues on a certain day, subsequently awarding a prize to customer(s) making predictions matching or close to the actual value, in exchange for the provision of customer data.

2. Prior Art

Now more than ever before, information is a crucial commodity for enterprises. It is not overstating the case to say that the performance of an enterprise depends on its ability to efficiently gather massive amounts of customer information of various kinds. While one of the most popular means for gathering information has been street polls, individuals in these times have little time, and few are likely to stop to answer questionnaires. The response to direct mailings with offers of promotional goods is generally poor. Despite the associated labor, printing, and postage costs, such conventional approaches are unable to gather a satisfactory amount of customer information.

Most enterprises now have their own home Web pages to describe their business, revenue, and customer services. However, such sites are rarely visited by potential customers, with results in this area that tend to fall short of expectations. The most likely reason for these disappointing results is the lack of an effective way to lure potential customers to the home page.

One aspect of the present invention provides a relatively inexpensive means for collecting information from a number of customers in a timely manner. The inventor has found that a method similar to a lottery, by which some applicants can win prizes under certain conditions, meets the interest of information providers (customers) and can therefore prove effective in collecting a sufficient amount of customer data in a timely manner.

The best areas for games involving such a lottery are the Nikkei Stock Average in Japan, the Dow Jones Industrial Average in the United States, and the Dow Jones Euro Stoxx in Europe. Challenging individuals to predict a future stock average is a unique attraction. To individuals interested in the economy and in stocks, predicting future stock prices represents an attractive challenge to their expertise. Other individuals may be inspired to begin keeping track of (for example) Japan's Nikkei Stock Average.

The Nikkei Stock Average is the 225-issue Nikkei Stock Average, also called the Nikkei Dow or Nikkei Dow Average. It is an indicator of overall stock trends, based on the average price of 225 stocks selected from the first section of the Tokyo Stock Exchange, as calculated by a corrected averaging method that corrects for the drawbacks of simple averaging. This indicator is made public on a near-daily basis through various media sources.

This indicator is generally a six-digit figure. Its leading two or three digits generally do not change if the interval between prediction and settlement is one to several months. This makes it relatively easy for individuals to predict a reasonably close value. Such lottery games could also involve predicting the future market price of certain commodities. In most commercial transactions, goods are exchanged for money simultaneously. In commodity futures, however, a transaction is made for a future exchange of goods and money, with certain expectations. Settlements are made in the future, and the real price of each commodity is determined by future supply-demand balances. Commodity futures play an important role in the economy, encouraging the formation of reasonable market prices and reducing price fluctuation risks. For example, the upper limit (Stop High) and lower limit (Stop Low) of the price of Azuki beans dealt in Japan are both four-digit figures. If the interval between prediction and settlement is brief, the leading and even second digits will rarely change over the period. This will encourage individuals to make precise predictions of future prices, considering nominal, asked, and bid prices.

Another lottery game involves predicting the number of guests who will visit a well-known or local restaurant or retail establishment on a future date, or over the span of a few days. The ultimate goal of the invention is to acquire customer data from information providers (customers), in exchange for the chance to participate in such a lottery.

Another important goal of the invention is to provide a means or method to encourage customers to visit the home page of the lottery sponsor on the occasions on which customers participate in such lottery games.

Specifically, the invention has a means for encouraging each information provider to enter his or her zip code, birth date, gender, and e-mail address before participating in a game involving predictions of values such as future Nikkei Stock Averages. This generates a list of customers with a demonstrated interest in, for this example, the stock market. Similarly, if the lottery game involves futures, a list of individuals who pay close attention to futures can be similarly generated.

If the lottery game involves predicting the number of guests at a restaurant, for example, the restaurant can use the lottery as a sales promotion to attract guests.

Eventually, the present invention will provide a means for preparing effective materials for direct mail campaigns; for example, through customer data analysis based on data for age, area of residence, and other factors.

In response to potential loss of interest should individuals repeatedly fail to make correct predictions, the invention provides a feature that ensures a certain number of winners in each round.

### SUMMARY OF THE INVENTION

The method for collecting customer information of the invention comprises a display means for encouraging a customer to enter his or her predictions of a future Nikkei Stock Average, commodity futures on a future date, the number of visitors to a retail establishment, or the retail establishment's revenue during a certain future period, along with personal data, including at least an e-mail address and birth date. This method also comprises another display means for storing said information, showing whether a prediction is right or wrong by comparing the prediction against an actual value when the actual value is identified, and showing the prediction closest to the actual value if there is no prediction equal thereto.

Specifically, an information provider (customer) enters his or her personal data using a terminal such as a personal computer, then sends the information to a host computer via a network such as the Internet. The personal data includes the user ID and predictions. On the host-computer side, the information sent by the user is compared against data stored on a server data storage medium for user identification. If the input personal data meets every requirement for identification, the information is stored on the server.

Once the actual value is known, the information stored on the server is compared against the actual value. If any customers have submitted a correct prediction, their personal data and the number of such customers are shown on the host-computer side.

Another aspect of the invention is its means for encouraging customers to submit their predictions of the monthly revenue of a certain company (usually the sponsor of the lottery) or the number of visitors to a restaurant or retail establishment for the next month. Because information providers (customers) generally do not have background knowledge concerning the company or its visitors, it is preferable to provide a hint on the company home page to help lottery applicants make reasonable guesses.

Preparing such means and methods in advance makes it possible to encourage information providers (users) to visit the company's home page. The system may have a function that prompts each visitor to enter his or her own password. If the system is set to deny access from customers who have not entered a password, the company can identify each customer who accesses the home page, increasing the value of the access data for the sponsor company.

Another aspect of the invention is that the means for showing the prediction closest to the actual value has a means for listing predictions in sequence, in order of proximity to the correct value. If no customer enters a correct prediction, a certain number of customers entering close predictions may be awarded prizes. In the invention, if a single customer makes a correct prediction, that customer takes the entire prize; if there are two or more such customers, the prize is evenly divided among them.

Another aspect of the invention is a means for indicating where in the sequence of guesses a certain prediction falls—for example, 10th, 50th, or 100th from the guess closest to the actual value. This increases the likelihood of winning, making the contest more vivid and enjoyable, thereby encouraging more customers to participate in the game.

### BRIEF DESCRIPTION OF THE DRAWINGS

The present invention will be better understood from the description of the preferred embodiment given below, in conjunction with the illustrations, of which:

FIG. 1 is a flowchart illustrating the operations of the invention; and

FIG. 2 is a data input window of the invention.

### DESCRIPTION OF THE PREFERRED EMBODIMENT

An embodiment of the invention is described with reference to an example that uses the Japanese Nikkei Stock Average as a lottery game.

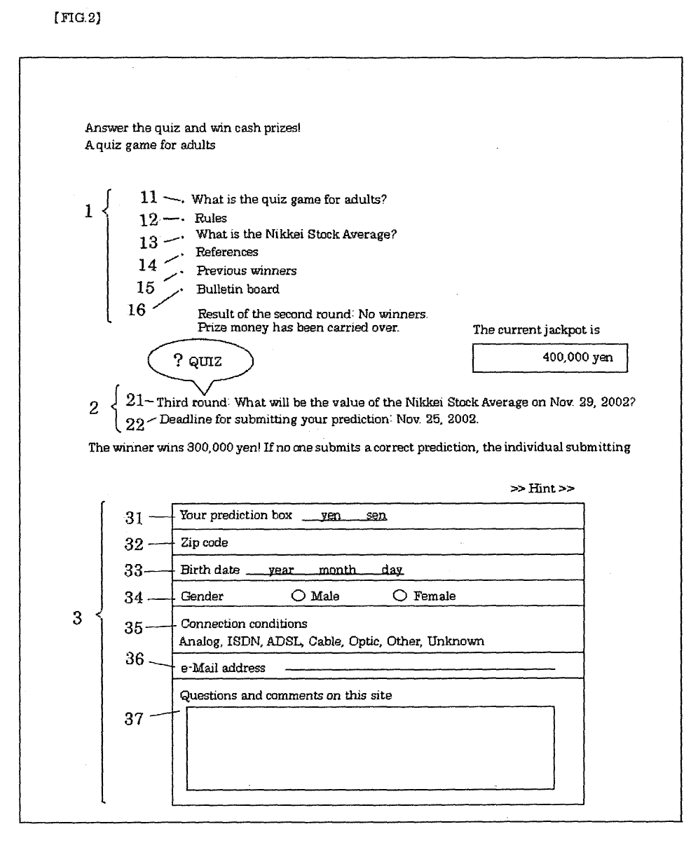

Information providers (customers) may be invited to post their predictions via banner advertising provided by a sponsor on the Internet. If a customer clicks on such banner advertising, the overview (1) of the quiz, question (2), and entry window (3) shown in FIG. 2 pop up.

The overview (1) of the quiz specifies or provides answers to the following: “What is the Quiz?” (11), Rules (12), “What is the Nikkei Stock Average?” (13), References (14), Previous winners (15), Bulletin board (16) and other information. If the customer clicks on “What is the Nikkei Stock Average?” (13), a window with a detailed description is displayed.

This embodiment uses the Nikkei Stock Average as the lottery game. If, on the other hand, the game involves the number of guests visiting a restaurant on a certain day, descriptions such as the menu and Chef's Special are displayed.

Question (2) encourages the customer to predict the Nikkei Stock Average for a certain future date (Month/Day/Year) (21), and also displays the deadline (22).

The predicted Nikkei Stock Average is shown in the “your prediction box” (31) in the entry window (3). Although the Nikkei Stock Average is usually a six-digit number, a customer may predict an unusual value; for example, a figure lower than 7000 yen or higher than 12000 yen. Since such a prediction (31) will almost certainly not be close to the actual Nikkei Stock Average for the future date, a comment box (37) should ideally be provided that prompts the customer to double-check for input errors and to confirm his or her entry.

The entry window has entry boxes for zip code (32), birth date (33), gender (34), e-mail address (35), and connection conditions (36), in addition to the prediction box (31).

The entry window can be coded appropriately to help the user input personal data. For example, on entry of a zip code (32), the corresponding location is retrieved and automatically entered by the system. Birth date data (33) is useful for generating customer lists by age; connection conditions (36) provide information on the customer's hardware configurations; and the e-mail address (36) provides personal information about the customer.

Thereafter, if the sponsor wishes to sell role-playing game software (for example), it can send direct mail to young customers who own a personal computer. If it wishes to sell Japanese chess software, it can send direct mail to older individuals living in Japan. In this way, the collected information increases advertising efficiency.

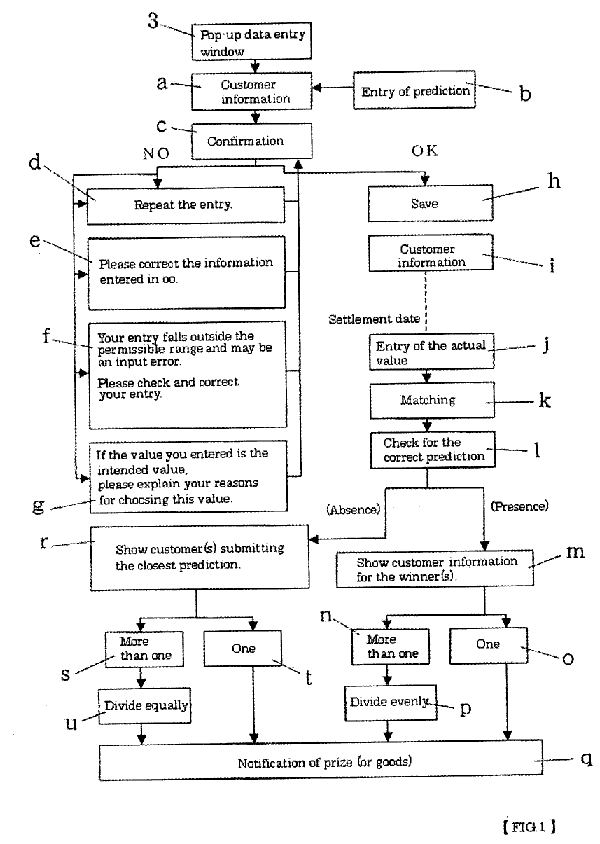

FIG. 1 is a flowchart illustrating the steps taken on the host-computer side.

In the above entry window (3), a customer (predictor and information provider) enters customer information (a) and a prediction (b). When a prediction (b) is entered, the system checks the entry for input errors (c). In the event of an input error, the customer is prompted by the system to repeat the entry (d). In this case, the system points out the field in which the error was found; for example, if the birth year entered is 3000, the system suggests that the customer correct this data (e). If a value outside an expected range is entered, the system prompts the customer to double-check and correct the entry (f).

If an unusual value is the actual value intended by the customer, the customer is in turn asked to provide the reason for entering such a value (g).

The procedural flow then returns to the error check (c). The entry is stored on the server (h) if no other errors are found. Customer information (i) acquired in this manner is held on the server until the deadline (22) of the quiz (2). The system does not permit data entry thereafter (22).

On the settlement date, the actual value is posted (j) and compared against customer predictions (k) saved on the server (h), to determine a match, if any (l).

If any customers have predicted the correct value, their names are listed (m) on the display. If only one customer (o) has predicted the correct value, the customer (winner) is so notified, and a settlement step (q) is performed to transfer the prize (money) to the customer.

If two or more customers (n) have predicted the correct value, the system divides the prize money (p) equally among them, and a step (q) is performed to transfer the divided prize portion to each customer.

If no one has predicted the correct value, the system identifies the individual making the prediction closest to the actual value (r). If the number of such individuals is one (t), that individual is immediately notified, and the process of payment of the prize money is carried out (q). On the other hand, if there are multiple individuals submitting the same closest value(s), the prize money is divided equally among them (u), and the process of payment of the prize money is carried out (q). Although the amount of prize money in such cases is set to a value less than that for a correct prediction, this arrangement reduces the possibility that prize applicants will lose interest, due to repeated failures.

The above embodiment is based on predicting the Nikkei Stock Average. For restaurants, one possible lottery would involve predictions of the number of guests on a certain future date.

Setting such a lottery target will encourage individuals to visit the restaurant in person in order to observe the number of guests on a typical day and thereby to improve their chances of making an accurate prediction. In this way, such a lottery will encourage new customers to visit a restaurant.

Furthermore, it is also advantageous to award prize money or goods to, for example, the 10th- , 50th- and 100th-best predictors.

As the settlement date (due date) approaches, it will become easier to make a correct prediction. Those who have already entered predictions far from the increasingly likely value may lose interest in the lottery. However, if prizes are awarded even to those submitting wrong predictions, for example, 100th- or 500th-closest predictions, applicants will be encouraged to continue to monitor the lottery until the settlement date.

In summary, the present invention using a lottery as a means for drawing the attention of many potential customers encourages them to enter their personal data into the entry system. Personal data can then be gathered from a broad range of customers. Analyzing, editing, and processing (if necessary) the information thus gathered will enable more effective sales promotions, such as direct mail campaigns.

What is claimed is:

1. A method for collecting customer information comprising:
a display means for encouraging customers to enter their predictions of future Nikkei Stock Averages, commodity futures for a future date, number of visitors to a retail establishment, or a retail establishment's revenue during a certain future period, along with personal data, including at least an e-mail address and birth date, which are to be stored; and
a display means for showing whether the prediction entered is right or wrong by comparing said prediction against the actual value when the actual value has been determined; and for showing the prediction closest to the actual value, if there is no correct prediction equal thereto.

2. The method according to claim 1, wherein said means for showing the prediction closest to the actual value also has a means for showing predictions close to the actual value by order of predictions closest to the actual value.

3. A method for collecting customer information comprising:
a display means for encouraging customers to enter predictions of at future Nikkei Stock Average, commodity futures for a future date, number of visitors to a retail establishment, or a retail establishment's revenue during a certain future period, along with personal data, including at least an e-mail address and birth date, which are to be stored; and
a display means for showing whether the prediction entered is right or wrong by comparing said prediction against the actual value when the actual value has been determined; and for showing predictions at various points, such as 10th, 50th and 100th, in the sequence of predictions closest to the actual value, if there is no prediction equal thereto.

4. The method according to claim 1, wherein if there are two or more customers who have made the correct prediction, the prize money payable to those customers is divided equally among them and shown in said display means.

5. The method according to claim 2, wherein if there are two or more customers who have made the correct prediction, the prize money payable to those customers is divided equally among them and shown in said display means.

6. The method according to claim 3, wherein if there are two or more customers who have made the correct prediction, the prize money payable to those customers is divided equally among them and shown in said display means.

7. The method according to claim 1, further comprising a means for encouraging customers, when making predictions, to view company information, such as the home page of a company receiving the customer information.

8. The method according to claim 2, further comprising a means for encouraging customers, when making predictions, to view company information, such as the home page of a company receiving the customer information.

9. The method according to claim 3, further comprising a means for encouraging customers, when making predictions, to view company information, such as the home page of a company receiving the customer information.
